(19) United States
(12) Patent Application Publication
(10) Pub. No.: US 2012/0253918 A1
(43) Pub. Date: Oct. 4, 2012

(54) ACTIVITY-BASED SOCIAL MARKETING SYSTEM

(75) Inventors: Jean-Francois Marois, Paris (FR); Tuhin Roy, San Francisco, CA (US)

(73) Assignee: FANZY, INC., San Francisco, CA (US)

(21) Appl. No.: 13/447,112

(22) Filed: Apr. 13, 2012

(30) Foreign Application Priority Data
Dec. 5, 2011 (FR) 11 03708

(51) Int. Cl. G06Q 30/02

(52) U.S. Cl. 705/14.39

(57) ABSTRACT

A user activity-based marketing system includes stand alone computer implemented application or an application within a social network rewarding users for participation in targeted social marketing of a product or service. The computer implemented method allows entities to provide incentives for users to engage in social marketing. Administrators controlling marketing efforts for an entity may define rewards for achievements or badges which recognize a user's level of influence and promote the entity. User activity, including social network activity, is tracked to determine whether a user has completed the achievement and gained access to a reward by engaging in social media activity defined by the achievement.

### CLAIM OF PRIORITY

This application claims the benefit of French patent application no. 11 03708, filed Dec. 5, 2011, and incorporated herein by reference.

### BACKGROUND

Social networks seek to encourage sharing of information amongst users having some relationship to each other. The basis of these relationships serves as a binding force between users, with a “friends” recommendation of a product or service generally carrying more weight than that of a stranger.

Suppliers of products and services have sought ways to utilize social networks to supply information about their product or service to consumers. Suppliers can establish a presence on social networks by official product or service pages or accounts that disseminate information about themselves to users of the network. Users generally can choose to follow these accounts on their own or at the recommendation of a network friend.

### SUMMARY

A customizable, user activity-based marketing system includes stand alone application or an application within a social network on the Internet that rewards users for participation in targeted social marketing of a product or service, referred to herein as an “entity”. The entity may promote itself with a page in a social network or may provide a public page outside the social network but desire promotion with in the social network. In one aspect, the technology is performed by a computer implemented method for providing incentives for users to engage in social marketing. Administrators controlling marketing efforts for the entity may define a number of achievements or badges which recognize a user's level of influence and promote the entity. The achievements are based on user social network activity relating to the online entity which represents a product or service. A plurality of users subscribe to receive offers based on the achievements from the online entity within the social network. A user interface is provided for each of the plurality of users associated with the online entity, the interface including the offers associated with the entity. Social network activity is tracked to determine whether a user has completed the achievement and gained access to an offer by engaging in social media activity defined by the achievement. Rewards, both real and virtual, are provided to the user based on completed social media activity satisfying an offer.

Users are incentivized by rewards and a display of their level of influence relative to the online entity and relative to all entities participating in the technology.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block level diagram of the present technology.

FIG. 2 depicts a block level diagram of a system suitable for implementing the technology.

FIG. 3 is a flowchart representing one embodiment of a method of the present technology.

FIG. 4 is a flowchart representing one embodiment for configuring a social marketing entity.

FIG. 5 is a flowchart representing one embodiment for re-configuring a social marketing entity in response to feedback.

FIG. 6 is a flowchart representing one embodiment for installing a social marketing application.

FIG. 7 is a flowchart representing one embodiment for presenting a user interface for a social marketing application.

FIG. 8 is a flowchart representing one embodiment for presenting a user dashboard user interface.

FIG. 9 is a flowchart representing one embodiment for determining user social activity.

FIGS. 10-18 illustrate various user interfaces of the present technology.

FIG. 19 is a block diagram of a mobile device.

FIG. 20 is a block diagram representing a processing device.

### DETAILED DESCRIPTION

Technology is provided for a customizable, user activity-based social marketing system. In one aspect, the system includes an application within a social network on the Internet that rewards users for participation in marketing of a product, service, group or individual, referred to herein as an “entity”. The entity may promote itself with a page in a social network or may provide a public page outside the social network but desire promotion within the social network. The technology provides marketing, customer acquisition and market research tools to marketing professionals.

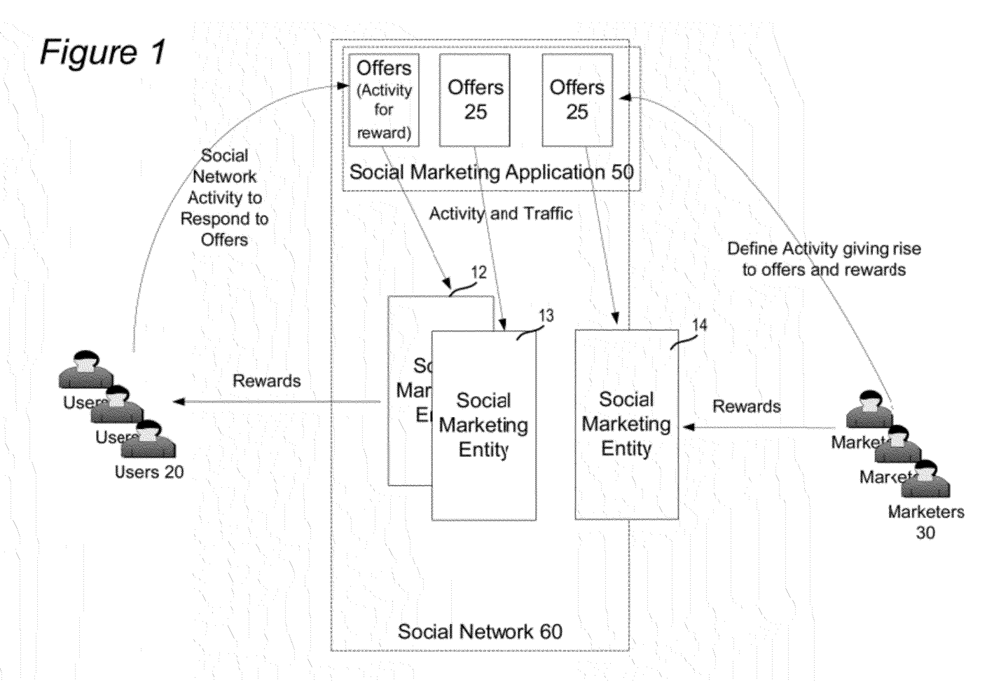

FIG. 1 is a block diagram representing the technology. In one aspect, a social marketing application 50 is utilized by users or consumers 20, and administrators or “marketers” 30 who promote and manage products and services. Products and services may be represented online by an online entity (12, 13, 14), such as a public web page or a web presence within a social network 60 such as Facebook®. Marketers may seek to drive user activity related to their online entity by users and can do so using the social marketing application by providing a plurality of offers 25. Marketers associate the social marketing application with the online entity to provide a social marketing enabled entity (12, 13, 14). Similarly, users associate themselves with the application by installing the application and providing access to personal information, allowing the application to track their social media activity. To access reward offers from marketers 30, users subscribe to social marketing entities through the application. Each offer may provide a reward for social network or social media activity of the user relative to certain user actions or goals tracked by the application and selected by the marketer to serve as the trigger for the reward offer. These actions are defined below, but in one context take the form of achievements or “badges” representing a level of influence tied to the social activity and social reach of a user. Marketers define achievements and offers within the social marketing application 50 and users access the application 50 to determine which activities are necessary to obtain rewards. Users can respond to offers by engaging in social media activity though the social network 60 which is tracked by the social marketing application relative to both the user and the social marketing entity.

Each marketer may, for example, manage an entity page or several pages in a social network. By installing social marketing application 50, the Administrator can add the social marketing application 50 on the page of the entity that it manages. The addition of the application on the entity creates social marketing application 50 for the entity. Social marketing application 50 for the entity then appears on a tab or another part of the page of the entity.

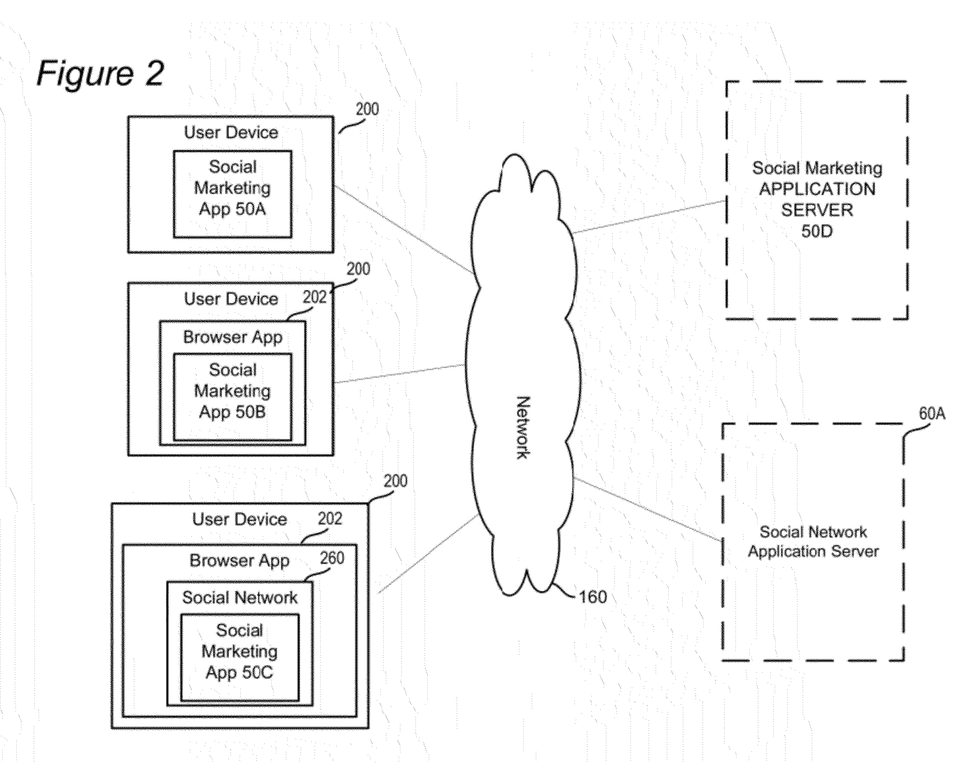

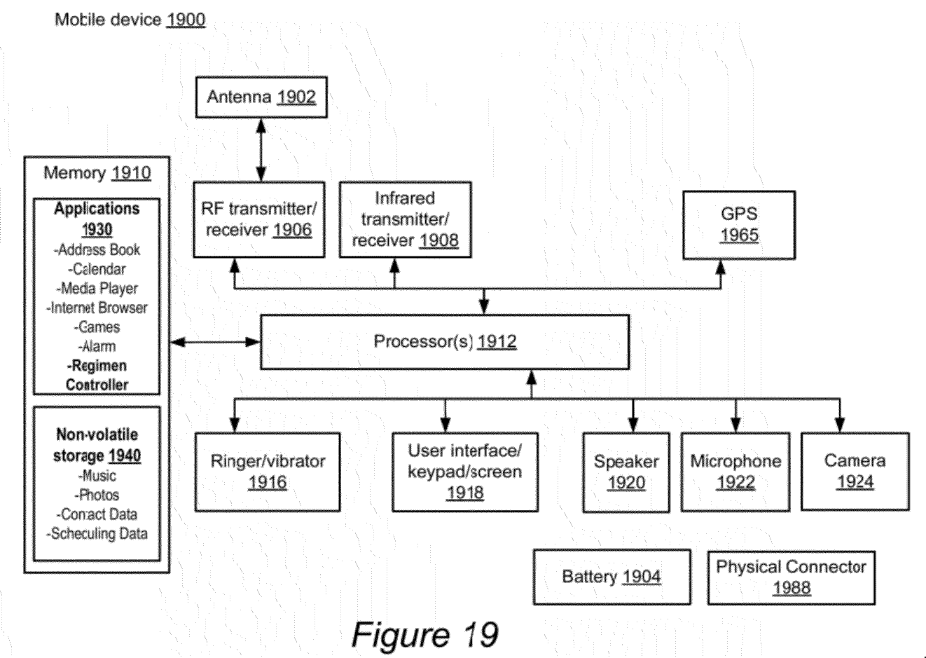

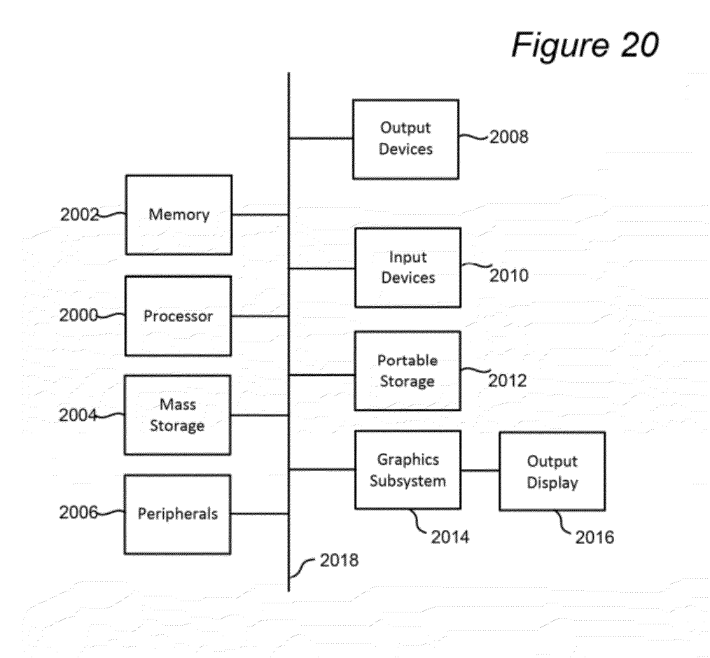

FIG. 2 illustrates a system suitable for implementing the present technology. In FIG. 2, multiple user devices 200 connect to social marketing application server 50D in a social network application server 60A through a series of public and private networks 160 and which may comprise the Internet. It should be understood that social marketing application server 50D and social network application server 60A may represent a plurality of computing devices such as those discussed below with respect to FIG. 20 operating in a data center to provide the services described herein. User devices 200 may comprise any of the computing devices discussed below with respect to FIGS. 19 and 20. As illustrated in FIG. 2, a social marketing application 50A may be a dedicated application operating on user device 200 and communicating with the social marketing application server 50D and social network application server 60A through network 160. Likewise, the social marketing application 50B may be provided in browser application 202 operating on a user device 200. In this example, the term social marketing application can be understood to be a set of instructions suitable for causing a processing device to implement the application within a browsing application, with the instructions provided by the social marketing application server through a series of communications over the network.

In yet another embodiment, social marketing application 50C may be provided within a social network application 260, which is itself resident in a browser application 202 on user device 200.

In one embodiment, the social marketing application is specifically designed to be provided for and interact with the Facebook® platform. As such, the application is rendered within the presentation of a Facebook® page or pages. In other embodiments, the social marketing application may be provided for and interact with other social network platforms. In this configuration, social network application server 60A provides a set of instructions for rendering a social network application 260 within the browser application, and through a series of communications with the social marketing application server 50D provides a rendering of the social marketing application 50C within the social network application 260. Any of the aforementioned configurations may be utilized in accordance with the present technology.

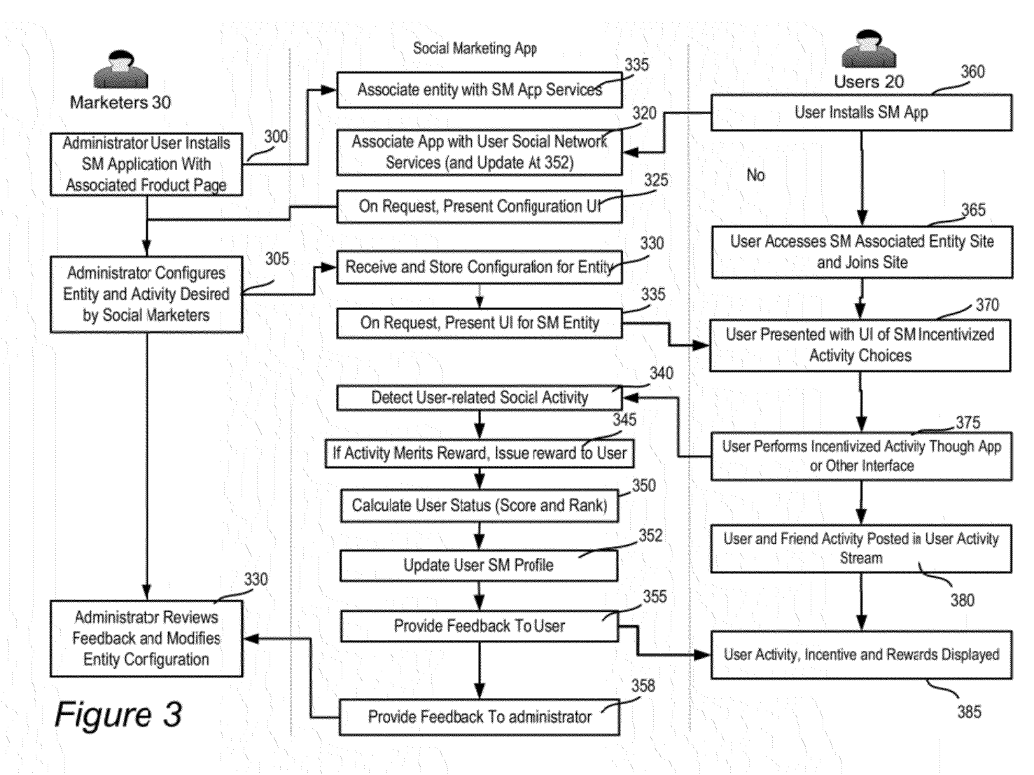

FIG. 3 illustrates a flow chart including the steps performed by three entities in accordance with the present technology. FIG. 3 shows a general flow chart and it will be understood that for specific operations with respect to specific social networks, certain variations in the flow chart may occur. Initially, at step 300, an administrator or marketer installs a social marketing application with an associated product page. Step 300 can be performed by the administrator with respect to an online entity for a product or service having online presence via a public addressable site, or for a product or service that has a web presence (e.g. a web page) provided within the context of a social network, such as Facebook® or Twitter®.

It should be understood that the terms product and service can apply to any type of entity having an online presence, including a physical product, an online or personal service, people, sports teams, athletes, artists, celebrities, brands, entertainment series, movies, video games, or any other type of entity.

When an administrator installs a social marketing application with an associated entity at 300, the social marketing application associates the entity with the social marketing application services at 335. In one context, this may include providing a link or other hook at the entity's online presence in order to allow regular users to access the social marketing application and allow the social marketing application to track information which results from user activities on the social marketing entity site.

Similarly, users 20 install social marketing applications at step 360. A user may select to install a social marketing application as a result of navigating to an entity which has the social marketing application enabled, or may navigate directly to a site provided by the social marketing application with links to entities having the social marketing application installed. Once the user selects to install the app at 360, the application is associated with the user and the user's social network services at 320, and a configuration profile (step 352) for the user is created. A configuration profile will track the user's activity and maintain records of the user's score and rank within the social marketing application.

At the administrator's request, at 325, the marketing application presents a configuration user interface, described below, which allows the administrator to configure activity desired by a social marketer at 305. In this case, the social marketers are the users who engage in social marketing and social media activity via social networks or through other means on the Internet. Configuration of reward activities desired by marketers is described below. Once a marketer configures the activity desired by social marketers, the social marketing application receives and stores the configuration for the social marketing entity at 330.

Users can access any number of sites which provide an online presence for a product or service. When a user accesses a site, they are presented with an option to subscribe to that product or service's social marketing entity in order to take advantage of offers from the entity. When a user accesses the social marketing associated entity site at 365, the user may request the user interface for the social marketing entity from the social marketing application at 335. At 370, the user is presented with the UI of the social marketing entity which includes incentivized activity choices. By engaging in the incentivized activity, a user promotes the entity and such may be recognized by one or more badges indicating a level of achievement for the activity. Once an achievement is reached, a reward may be associated with the achievements (or multiple achievements). Subscribing to the social marketing entity of a product or service is variously referred to herein as subscribing or becoming a “fan” of that product or service.

Once the user accesses the user interface at 370, the user can perform incentivized activity through the application or through another interface, such as a direct interface with the social network at step 375. If for example the user interface is Facebook, the user can choose to provide a public post of a status within the Facebook interface. If the social network is, for example, Twitter, the user can send a “tweet” through the Twitter system. Both such activities, as well as other types of activities through other social networks, can be accessed by the social marketing application through a series of application programming interfaces (APIs) which social networking services make available to third parties to detect activity within the social network. Alternatively, these APIs can be used by the social marketing application user interface to connect to the social network and input data into the social network. Once the activity is performed at 375, the activity may be posted in the social network stream at 380. At this point, the social marketing application will, at step 340, detect user-related social activity and at 345 if the activity merits a reward, issue a reward to the user. A user may redeem a reward (at step 385) by, for example navigating to a link on a third party site, or submitting other redemption information as required by the entity offereing the reward.

In addition, at 350, the social marketing application will calculate the user's level of influence via a ranking within the social marketing entity for the user, as well as a user's influence in relation to other users within the social marketing application at 350. This is reflected as a score indicating a user's level of influence (a “FanScore”) and their ranking relative to other users based on their FanScore and their activity on social networks and their purchases (a “FanRank”). At 352, the user's profile within the social marketing application will be updated at 352, and feedback may be provided to the user at 355 in the form of a user interface displayed to the user at 385. Examples of the user interface and the type of feedback provided are discussed below. In addition, feedback can be provided to the administrator at 358. This allows the administrator to review the feedback and modify the entity configuration and rewards accordingly at 330. Page administrators have access to statistics on the activity of users utilizing the social marketing application and participating in the social marketing entity. These statistics include:

the number of users participating in the social marketing entities;

the reach of the group of users in the social marketing application (including, for example, the total number of friends a user has, and what the users do across multiple social networks);

the number of published articles on social networks by this group of users; and

the number of social reactions to published articles generated by friends of the group of users within the social marketing application.

Usage statistics on the keywords used by the group of users

In addition, administrators can also view, for a social marketing entity:

an analysis of recurrent conversations in the group of users of the social marketing application;

the feeling (positive or negative) expressed by the group about the entity and key words defined by the administrator;

other pages that most interest a group of users; and

all other pages that most interest friends of the group of users.

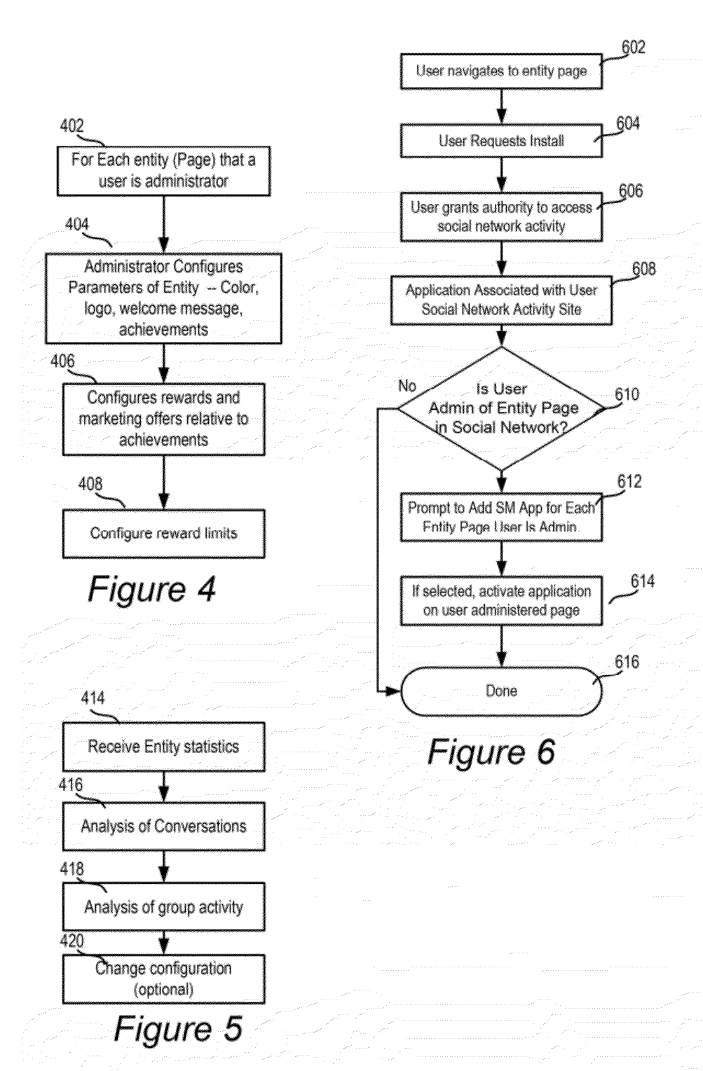

FIG. 4 is a flow chart illustrating one embodiment for performing the configuration step 305 of FIG. 3. At step 402, for each entity or entity page that a user is an administrator of, at 404, the administrator configures parameters of the entity. In configuring the site and activity, the administrator may select and vary several parameters that determine the appearance and operation of social marketing application 10. Among these parameters, the administrator may choose to define key words that will be used as a basis for determining the user's FanScore (defined below) and social marketing application FanRank (also defined below) for users participating in the social marketing application for a social marketing entity. The administrator can also set up other social marketing application parameters such as:

the type of incentivized activity which results in achievement recognition;

the dominant color of the social marketing application on the page of the entity;

adding the logo of the entity to the social marketing application 10;

choices related to the automatic and periodic distribution of messages on the page of the entity (including the date and time of publication, the message text to be published, and other variables);

the welcome message posted on the social marketing application;

the image used to represent the entity on its social marketing application;

additional information posted by the social marketing application on its website;

the posting of rewards and offers available to users;

the authorization of other page administrators who can view rewards for users of the social media application;

the type of fan leaderboard to be displayed on the home page of the social marketing application (daily, weekly, monthly, or all time); and

the addition of the connection of another page to the same entity within the social networking application.

These choices are illustrated below with respect to the user interface.

At 406, the user configures rewards and marketing offers, and at 408 the user configures reward limits. This configuration allows the marketer to target its offers to one or more ordinary users by:

participation in the entity social marketing application 50;

participation in another entity social marketing application 50;

geographic location;

gender;

age;

pages that the user is a fan of on a social network;

having obtained (or not obtained) social activity achievements (or badges);

the level of influence as determined by a user's FanScore.

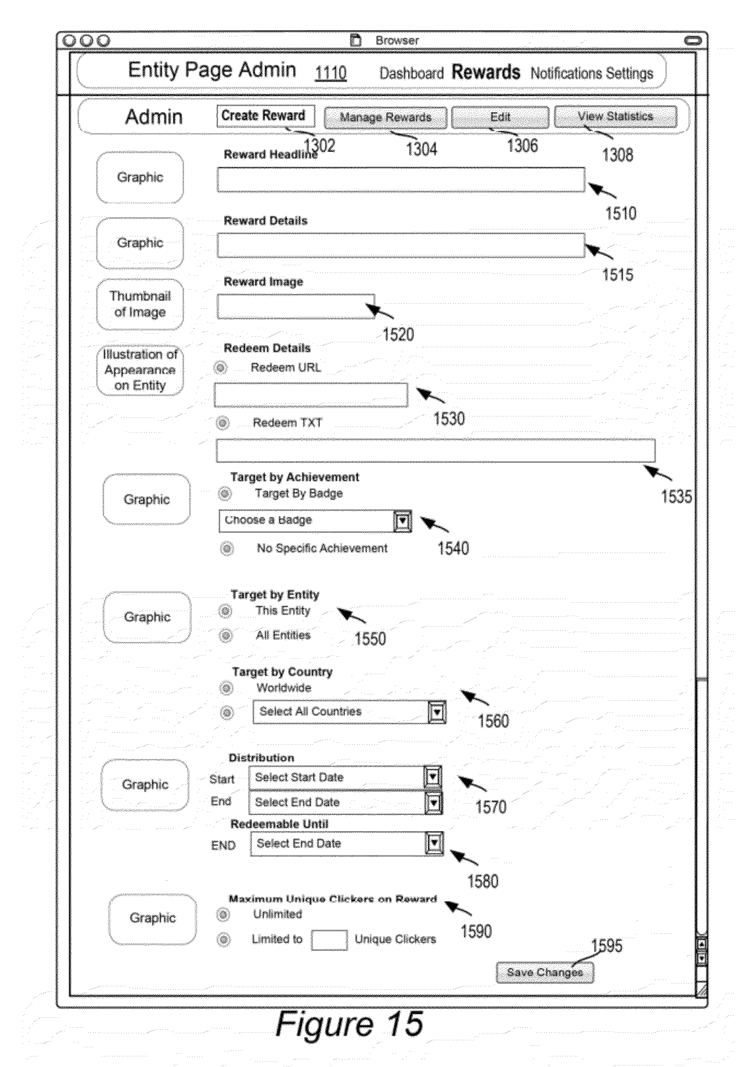

In the context of providing these offers, administrators can also limit the number of times that a reward can be used and specify the dates during which the rewards are available. Configuration of offers, achievements and limits is illustrated further below with respect to FIG. 15.

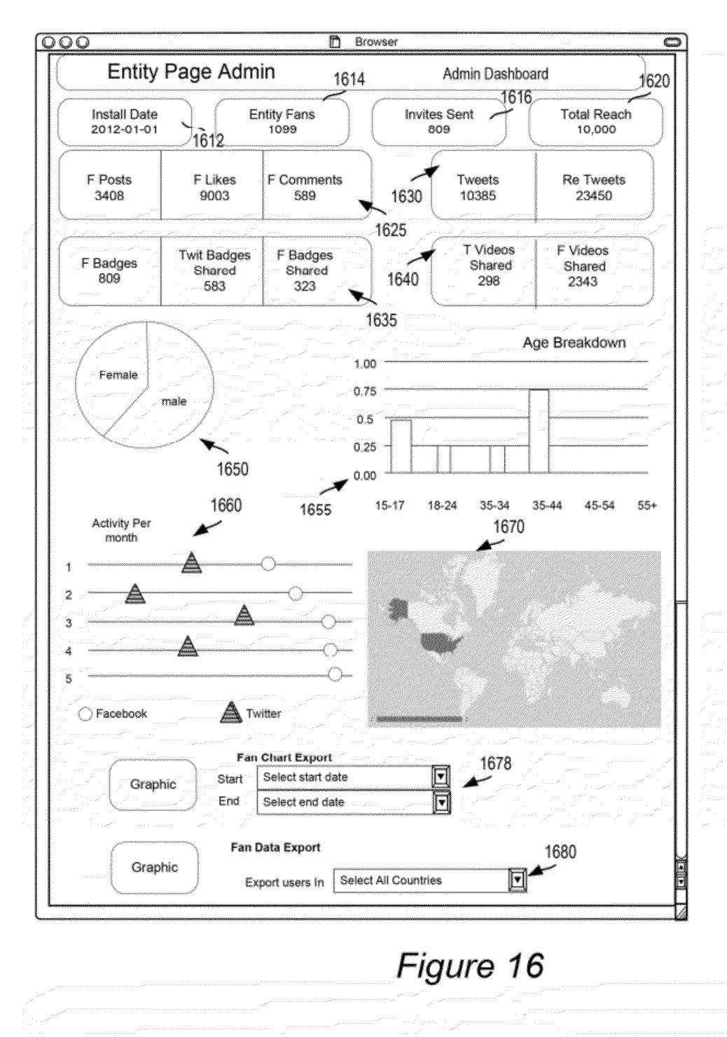

FIG. 5 is a flow chart figuring one embodiment performing the review of feedback and modification discussed above with respect to step 330. At 414, the statistics for a particular entity are displayed in a user interface, describe below with respect to FIG. 16. At 416, an analysis of the conversations and social activity between users is displayed, and at 418 an analysis of group activity within the social network relative to the entity is displayed. At 420, the user administrator can make additional configuration changes to the offers and the entity page.

FIG. 6 is a flow chart illustrating one embodiment for implementing step 360 discussed above. At step 360, a user installs the social marketing application by first navigating to an entity page at 602 which has the social marketing application installed, or alternatively by navigating directly to a user interface provided by the social marketing application, either via social network or via a publicly addressable page on the Internet. At 604, the user requests installation via a link on one of the aforesaid pages. At 606, the user will be presented with one or more interfaces to grant authority to the social marketing application to access the user's social network activity. Different social networks have different types of authoritative processes, including requiring the user to log into separate interfaces and authorize each application attempting to access the API of the social network. Once this access is granted at 606, the social marketing application is associated with the user and the user's social network activity at 608.

At this point, the application provides a viral expansion feature by allowing a user the option of installing the application on any pages that a user also administers. At 610, determination may be made by the social marketing application in conjunction with the social network application as to whether or not the user is an administrator of an entity page within a social network. For example, if a user manages an entity page within, for example, Facebook, then, at 612, the user will be prompted to add the social media application for each entity page for which the user is an admin. This may be provided by a single prompt illustrating the user's other entity pages, or multiple prompts for each entity page. If the user chooses to add the social marketing application to other entities, or just the initial entity, the application is activated at 614 on one or more pages that the user administers. If the user is not a page or entity administrator, the process ends at 616.

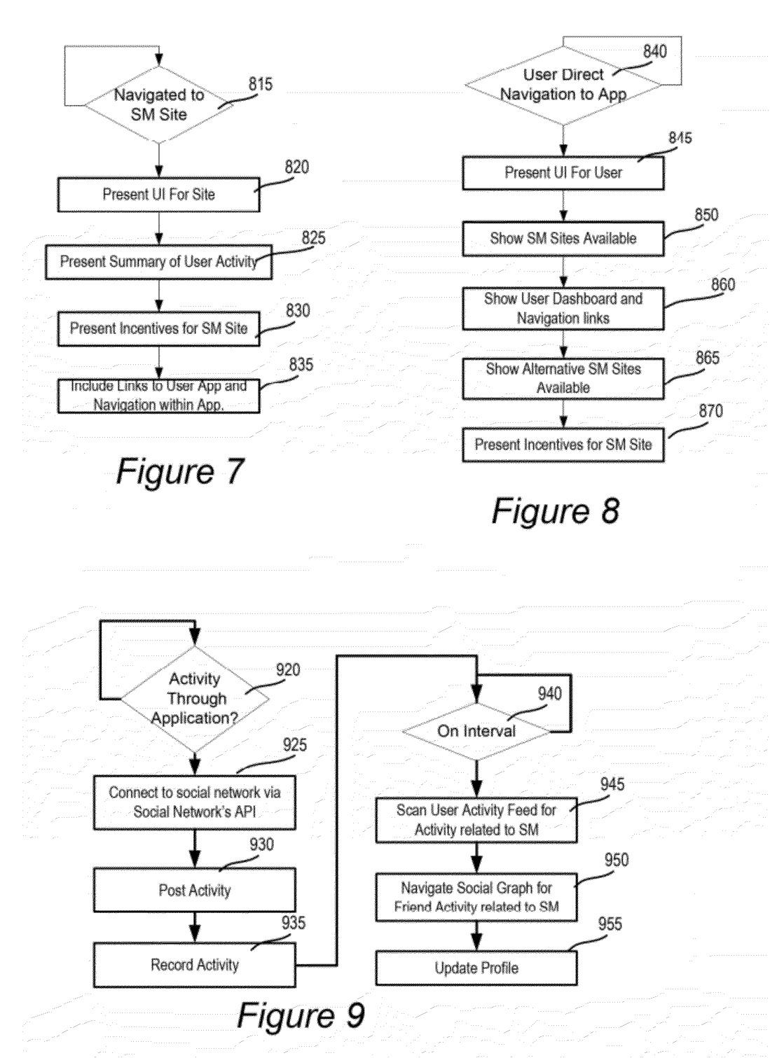

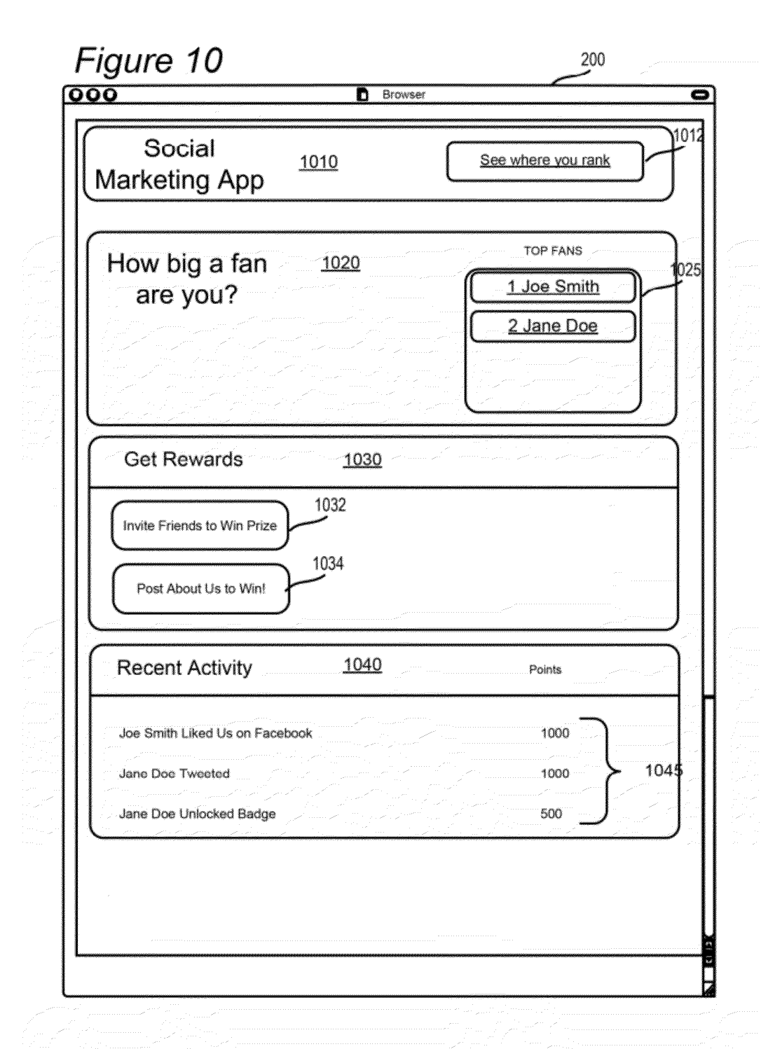

FIG. 7 illustrates one method for performing step 365 discussed above. At 815, if a user navigates directly to a social marketing enabled entity, a social marketing entity user interface is presented at 820. The user interface may include at 825 a summary of user activity, and incentives directed specifically for the social marketing site at 830. The social marketing entity will also include links to the user specific user interface at 835 as well as link is to configuration settings and feedback pages for the user. Various embodiments of user and administrative user interfaces are discussed below with respect to FIGS. 10-18.

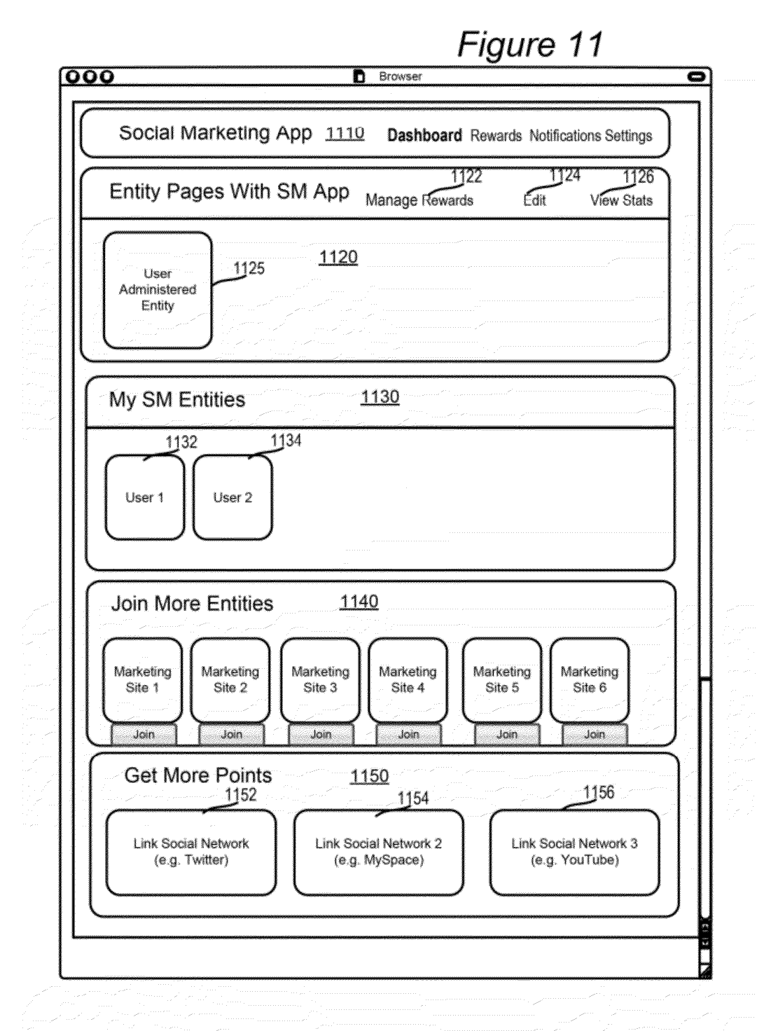

FIG. 8 illustrates an alternative method for performing step 365 where user navigates directly to the social marketing application associated with the user. For example, a user's social network page may include a link to the social marketing application, allowing the user to access an interface showing the user's profile and subscribed social marketing entities. If the user navigates directly with the social marketing application 840, a user interface specifically configured for the user is presented at 845. The user interface for the user will include, for example, at 850 social marketing sites which are available to the user, a user dashboard and navigation links at 860, alternative social marketing sites available at 865, and incentives for select sites at 870. An example of the user interface presented at 845 is discussed below with respect to FIG. 11.

FIG. 9 is a method illustrating one embodiment for performing the step of detecting user-related activity at step 340 discussed above. If a user participates in social media activity through the application at 820, when the application connects to the social network via the social network's API at 825 and activity is posted at 935. For example, interfaces in the social marketing application allow a user to directly post information to the user's social network activity stream through the API. This information can be recorded directly by the social marketing application.

Alternatively, at intervals 940 or at a time determined by the social marketing application, the user's activity feed for activity related to a particular social network is scanned at 945. Again, this can be performed by scanning, for example, the user's activity feed in Facebook or the user's Twitter feed in Twitter. At 950, the user's social graph may be queried to determine whether friend activity related to the social marketing entity has been performed by user's friends. Rewards may be provided for getting other users to repost the same material that a user posts. Querying the social graph at 950 allows tracking of this activity to other users and expansion of the social marketing audience. At 955, the user's profile is updated. As noted above, with respect to step 350, the user status is calculated relative to a FanScore and a FanRank. Once installed on top of an entity's social network page, the social marketing application 10 allows ordinary users to discover their level of influence via the FanScore and FanRank. Social Marketing application 10 encourages users to get real and virtual rewards for publishing a communication of marketing messages to their friends in social networks as well as other social activities and shopping.

When the user installs a social marketing application at step 360, the social marketing application retrieves personal data related to the social network to allow the social marketing application to calculate both the FanScore and the FanRank. Users who have installed the social marketing application can discover their FanScore and FanRank directly within the application itself or via the social marketing entity sites. Users who have subscribed with social marketing entities can navigate between subscribed social marketing entities. When a user signs up for his first social marketing application at 360, and installs the application, the social marketing application recovers user-related social network activity such as:

the history of a user's status updates;

social actions of a user's friends on the user's status;

the user's affinity for other pages on the social network;

the affinities of a user's friends for other pages on the social network;

the history of statuse updates of the user's friends on the social network;

the date of birth of the user;

the user's geographical location;

the user's friend information; and the user's e-mail address.

Social marketing application also calculates an initial FanScore and initial FanRank for the entity using a mathematical algorithm. Once calculated, the FanScore and FanRank are displayed to the user. Incentivized social activities comprise an action or a series of actions that enable a user to improve the FanScore and FanRank and provide the user with different types of rewards. These incentivized activities for which a user may earn an achievement or badge may include, for example:

publishing a message with a key word defined by the administrator on a social network;

associating the user with the page of the entity on a social network;

the purchase of specific products;

reporting to a certain place of certain time (such as attending a concert or sporting events);

scanning a bar code or QR code distributed at a physical location.

The FanRank of a given user who is a subscriber to a social maketing entity may be calculated based on the number of keywords contained in the given data from the server to the subscriber as well as other factors, including the amount of engagement from that user's friends with posts made by the user, communications a user makes with other users, invitations to participate in the social marketing entity and the actions on those invitations.

The social marketing application calculates a first rank for the subscriber, based on data received from “Facebook” to determine user influence relative to the entity. In particular, to calculate the influence of the subscriber relative to the entity, the following variables may be utilized:

Average number of likes collected on status updates about the entity;

Average number of status updates about the entity in general;

Average number of comments collected on status updates about the entity;

Average number of comments on status updates in general;

Average number of likes on status updates in general

Total number of unique commenters on Facebook in general;

Total number of unique Likers on Facebook in general;

Number of friends on Facebook;

Total number of friends who like Facebook page;

Total number of friends involved in the social marketing entity;

Total number of friends included in the social marketing application in general;

Whether the subscriber “likes” the page; and

Total number of status updates.

Based on the above factors, a number of points given for each factor is used to calculate a weighted score of the user's influence to obtain a final ranking of each user-subscriber relative to the Social Marketing Entity. The marketer can then target customers and subscribers who have a score above a threshold and avoids contact with subscribers for which there is little interest.

The above description was made taking as an example in the social network “Facebook”. The process works the same way as with other social networks, such as “Twitter”, “LastFM” “Youtube” and the like. When a subscriber is a member of several of these networks and installs the social marketing application for several of his accounts in different social networks, the social marketing application has the added benefit of centralized data to a given subscriber, allowing the service provider to reduce the processing time which is necessary to obtain this information by connecting successively each of social networks.

A calculation of the ranking of a subscriber from a particular service provider (e.g “last FM”) may be based on the following calculation:

$$LFM = \frac{100}{2 \sqrt{1350} + \sqrt{5000}} [ 2 \sqrt{min ( A , 1350 )} + \sqrt{min ( B , 5000 )} ]$$

where
A=number of plays of songs by the entity on last.fm listed in the last 6 months
and B=number of plays of songs by the entity listed on last.fm of all time

For Facebook, a sample calculation is:

$$FB = 1 / 4 [ 2 \frac{Min ( 95 \% \sqrt{C} , \sqrt{C} )}{Avg \sqrt{C}} + \frac{Min ( 2.72 , E )}{1.07} + 4 \frac{Min ( 95 \% \sqrt{D} , \sqrt{D} )}{Avg \sqrt{D}} + 2 \frac{Min ( 0.845 , F )}{0.14} ] + 1 / 2 [ \frac{Min ( 3.87 , \sqrt{G} )}{1.83} + \frac{Min ( 6.24 , \sqrt{H} )}{2.49} ] + 1 / {4}^{*} [ \frac{Min ( 1185.5 , I )}{420} + 2 \frac{Min ( 95 \% \sqrt{K} , \sqrt{K} )}{Avg \sqrt{K}} + 3 \frac{Min ( 95 \% \sqrt{J} , \sqrt{J} )}{Avg \sqrt{J}} + 2 \frac{Min ( 2.45 , L )}{0.48} ] + 3 M \sqrt[+]{\frac{Min ( N , 1000 )}{10}}$$

$$FB = \frac{100. Min ( preFB , 99.5 \% preFB )}{99.5 \% preFB}$$

where
C=Average number of “likes” on status updates about the entity;
D=Average number of unique commenters on status updates about the entity;
E=Average number of “likes” per status update in general;
F=Average number of unique commenters per status update in general;
G=Total number of unique commenters on status updates in general;
H=Total number of unique “likes” on status updates in general;
I=Number of friends on Facebook;
J=Number of friends participating in the social marketing entity;
K=Number of friends who “like” the entity's page;
L=Number of friends registered for the social marketing entity;
M=User “Likes” the entity page (yes=1, no=0);
N=total number of status udpates about this entity.

For Twitter, the FanScore may be calculated as:

preTW=O*O/P*S/R/100,000+T/20+3U+Q/1000

$$TW = \frac{100. Min ( preTW , 99.5 \% preTW )}{99.5 \% preTW}$$

where:
O=Number of followers on Twitter;
P=Number of accounts that the user follows on Twitter;
Q=Total number of tweets posted by the user;
R=Total number of tweets received (@ mentions);
S=Total number of retweets (RT) received by the user;
T=Total number of unique ReTweeters;
U=The user follows the entity on Twitter (yes=1, no=0)

To calculate a FanScore for the user,

FANSCORE FB=0.5+0.4+0.1TWLFM

This score is calculated on the principle of giving, for a given variable, the maximum value to the subscriber as soon as the variable exceeds a threshold value calculated in advance by the application. Each variable is transformed by the equation so that its population distribution (for all subscribers to the social media entity) fits a Bell curve. This ensures that the subscribers achieving a top five percent value for a variable, all have the same maximum value possible for this variable (e.g. 95% of the variable). This is to avoid outliers in the calculation of the score, which can in particular be related to abuse of the system by a subscriber to artificially increase their total score. Thus, use of 95% or 99.5% mulitiplied by the variable in the above equations represents a distribution of X for all users of the social marketing entity; and
Avg X represents the average value of X on the distribution of X for all users of a social marketing entity; and
Min (X, Y) equals X, if X<Y, and Y if X>Y.

In addition, in each of the aforementioned equations, each variable is weighted according to its importance in the ranking and score calculation. This weighting makes it easier for an average user to move up in influence initially, but harder as the user reaches higher levels of influence.

Multiple social networks may be used in accordance with the present technology. The network may be, for example, “Facebook”, “Twitter”, “Youtube”, “LastFM” or similar social networks.

FIG. 10 illustrates a user interface which may be presented to the user at, for example, step 335 once the user has signed up for a social marketing application as a result of navigating through a social marketing enabled entity. The user interface may be presented, for example, in a browser 200, although in alternative embodiments, the user interface elements may be presented by a dedicated application, as described above. A mast head 1010 indicates that the user is viewing the social marketing application and includes an activation element, such as a link 1012, allowing the user to see the user's rank in relation to other users of the social marketing entity. A second panel 1020 displays the top fans (subscribers) for the social marketing entity in a list at 1025. A get rewards panel 1030 shows exemplary offers 1032 and 1034 which encourage the user to engage in social networking activities in order to obtain rewards. By selecting one of the activation elements 1032 or 1034, the user navigates to an interface allowing the user to participate in the rewards offered. A recent activity panel 1040 showed a list of users 1045 who have participated in, for example, one of the rewards shown at 1030, or other rewards, the type of activity the user participated in as well as how many points the user received for participating in this activity. As noted above, the user's points can be used to calculate the user's FanRank.

FIG. 11 illustrates a user interface which may, for example, comprise a user profile provided to the user when a user navigates directly to the social marketing application. A user dashboard panel 1110 includes links to allow the user to view the dashboard (shown in FIG. 11), access the rewards page, access the notifications page, or access user settings. As illustrated in FIG. 11, the dashboard link is highlighted, indicating that the user is viewing the user's dashboard page.

As noted above, each user may themselves be an administrator of a social marketing entity. Panel 1120 illustrates social marketing entity pages associated with the social marketing application which the user may administer and on which the user may choose to install additional social marketing applications. Graphic 1125 illustrates a user-administered entity for which the user installed the social marketing application. A manage rewards link 1122 allows a user to view rewards associated with the entity pages illustrated in panel 1130 for which the user has installed a social marketing application. The edit page link 1124 allows the user to edit the social marketing application for the particular page, to modify the preferences discussed above. The view statistics link 1126 allows the user to access the statistics panel for the entity, described below. As noted above, the entity panel 1130 illustrates social marketing enabled entities that the user has subscribed to. Graphics 1132 and 1134 illustrate the users social marketing entity subscriptions, allowing the user to easily navigate to the social marketing entity. Panel 1140 presents a series of additional social marketing entities for which other administrators have installed the social marketing application and for which the user viewing the user interface in FIG. 11 may wish to join. It should be noted that the panel 1140 may also present product or service entities that are members of the social network for which the social marketing application has not been installed, inviting the user to start a social marketing fan site for the entity. A “get more points” panel 1150 allows the user to link additional social networks 1152, 1154, 1156 to the user's profile.

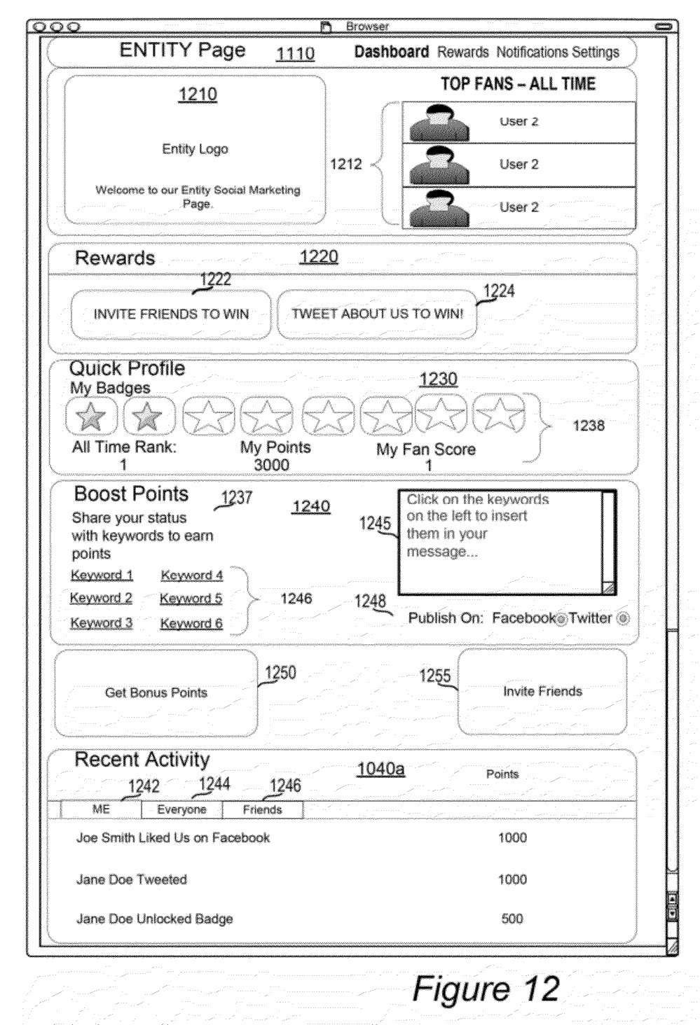

FIG. 12 illustrates a user interface presented by a social marketing entity to which a user is subscribed. In the entity page illustrated in FIG. 12, a link to the user dashboard 1110 remains, but a specific entity logo 1210 is displayed. The entity logo has been selected by the administrator as discussed above. A list of top all time fans 1212 is presented next to the entity logo. A rewards panel 1220 presents highlighted reward and, for example, limitations on the reward. As noted below, administrators can configure a limited number of offers or limited times that the reward may be redeemed. A quick profile panel 1230 illustrates the user's award badges which have been achieved for incentivized social activity relative to this social marketing entity. Badges may be earned for social network activity and in one context, are used to earn rewards offered by the entity.

As noted above, badges may be earned for numerous different types of social activity including, but not limited to, achieving a certain FanRank, achieving a certain FanScore, inviting others to use the social marketing application or become a subscriber to an entity, publishing a message with a key word, an initial subscription to an entity's social network application, purchasing products, or other activities as described herein. Once the activity has been achieved (as determined by reference to the user's social activity feed), the achievement or badge is awarded to the user an, where a reward is available for completing the badge or a series of badges, the user may redeem the reward by navigating to the appropriate rewards interface. Badges may be defined by an administrator or provider of the social networking application, allowing marketers to choose from a number of defined activity badges from which to create a reward. In alternative embodiments, marketers may define their own badges. Badges may be defined for on-line activities (posting an item with certain key words, for example), as well as off-line activities (showing up in person at a particular location).

In addition, a status panel 1237 illustrates the user's all time rank relative to the social marketing entity, the points achieved within the entity, and the user's FanScore relative to the entity: A boost points panel 1240 offers the user an interface and the ability to increase the user's points by sharing the user's status via an entry interface 1245 which is connected to, in this example, the Facebook and Twitter APIs to publish the user's status using one of the key words 1246. By doing so, the user will increase the user's points, and activate the applications connection to the user interface to allow the user to increase the user's points within the social marketing entity. A bonus points panel 1250 can include offers such as “liking” the social marketing application on Facebook, or posting a particular status, or otherwise providing one-time offers to increase the user's points. Invite friends panel 1255 encourages the user to invite the user's social network friends to participate in the social marketing application entity.

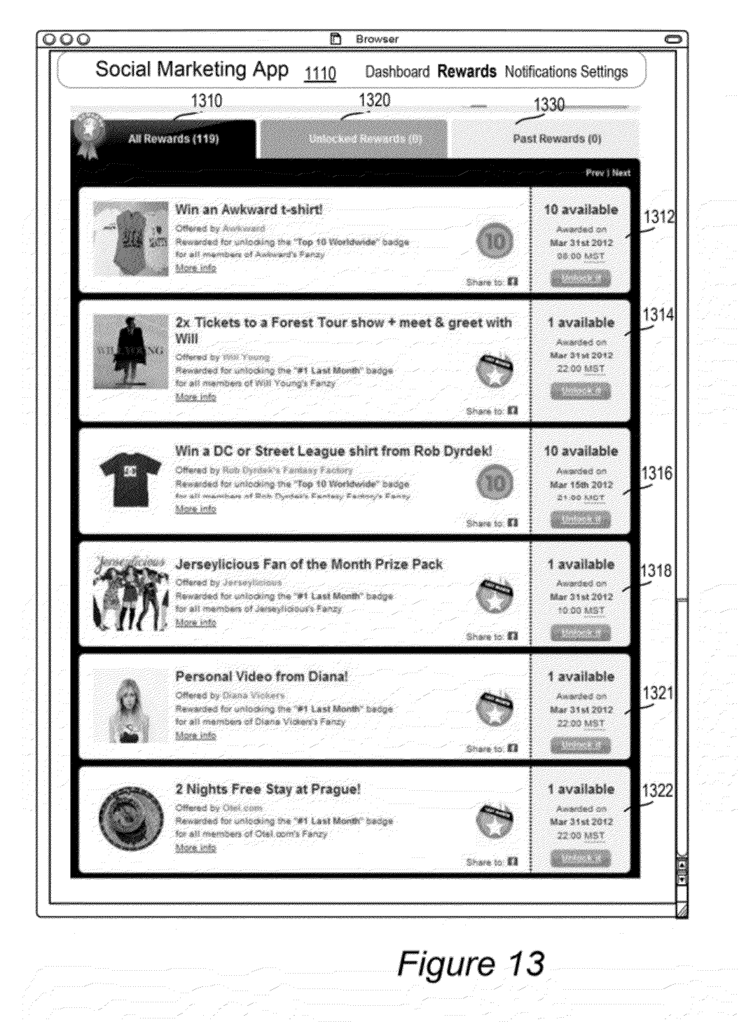

FIG. 13 is an illustration of an interface when a user selects to redeem various rewards. The interface shown in FIG. 13 may be presented when a user navigates to their own application page, and is not associated with any particular social marketing entity, although an interface similar to the one shown in FIG. 13 can be provided from any social marketing entity. Tabs 1310, 1320 and 1330, allow the user to select between showing all rewards available, unlocked rewards, and the user's past rewards. Various rewards 1312, 1314, 1316, 1318, 1321 and 1322 show the reward which is available, who offered the reward, how many are available, and any limits on the reward which is available.

In order to “unlock” a reward, in one embodiment, the user needs to have completed the necessary “badge” of activity. For Example, offer 1312 to redeem an Awkward t-shirt is achieved by unlocking the “top 10 Worldwide” badge, by being one of the 10 highest ranked users of the Awkward Social Marketing application. By selecting the “unlock it” link, a user can be directed to a social marketing entity to achieve the reward. Clicking the unlock it button will transport the user to the Awkward social marketing entity. Once the badge is achieved, and if the badge is achieved before limits on the reward have expired, the reward can be redeemed by the means defined by the administrator of the Awkward social marketing entity.

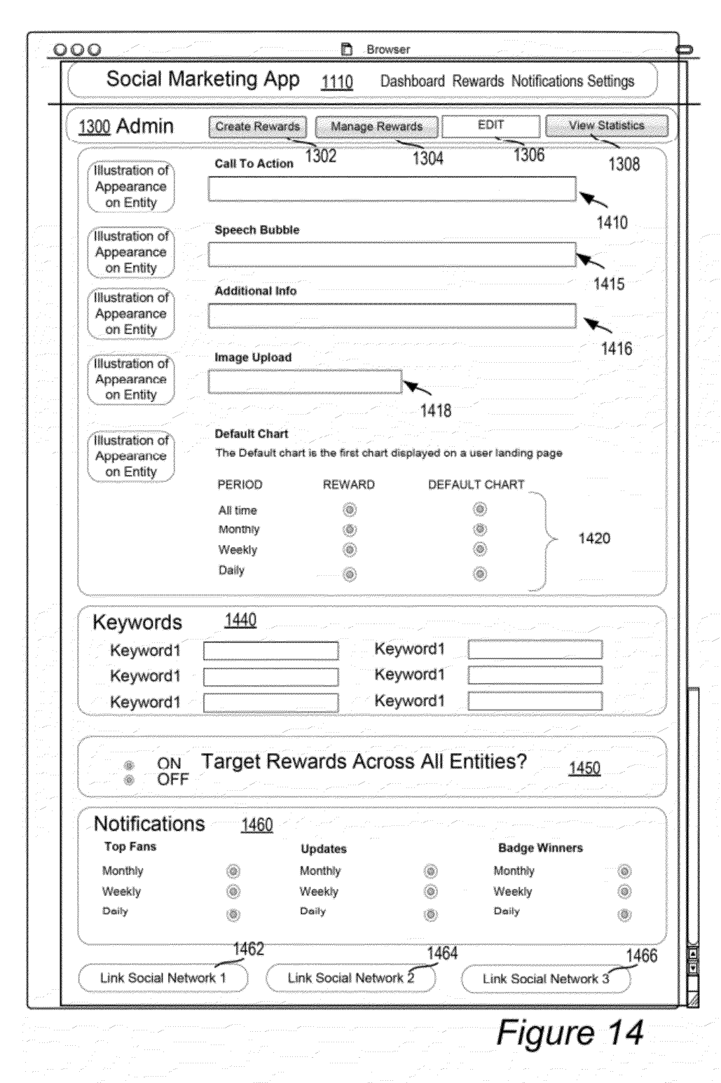

FIG. 14 illustrates a user interface which allows the user acting as an administrator to create and edit a social marketing entity. An admin panel 1300 allows the user to navigate to a create rewards page at 1302, a manager rewards page at 1304, this edit social marketing entity user interface at 1306, and view statistics at 1308.

At 1410, a “call to action” may be provided. A call to action is a phrase which may be displayed by the social marketing entity as a lead in to the social marketing entity's site. One example would be “how big a fan are you.” The administrator can enter any text in the entry field of element 1410. At 1415, a speech bubble, allowing the user to enter a subscript of text below the logo on the social marketing entity site is provided. Additional info entry 1416 is a freeform text field allowing the user to add any additional information the user wishes to appear in a popup on the social marketing entity site. Image upload interface 1418 allows the administrator to upload the graphic or logo that the administrator wishes displayed on the social marketing entity site. A default chart interface 1420 allows the administrator to specify the fan leaderboard which appears on the social marketing entity site, and add a reward icon on a leaderboard which can appear on the site as the first chart displayed on a user landing page. Each of the interface elements 1410, 1415, 1416, 1418 and 1420 has an associated illustration of the appearance of the interface element on the social marketing entity site.

Panel 1440 allows the administrator to define any number of key words that are picked up by the scanning algorithm discussed above which awards points to the users who are fans of the social marketing entity.

Panel 1450 allows the user to determine whether or not rewards are sent to users in other social marketing enabled entities or are limited to the particular social marketing entity being edited. This allows the administrator to target the reward across other entity sites using the social marketing application, or limit rewards to appearing to users navigating to the entity's specific social marketing application.

Panel 1460 allows additional configuration of notifications to various social networks and within the social marketing application entity. For example, the top fans notification may post the top five fans from a default chart to the social marketing application entity's own Facebook® wall and posts the top three fans to the entity's Twitter® account. The updates notification posts to the social marketing application entity's own Facebook® wall and Twitter account when the administrator has added new key words, videos, rewards or other offers. The badge notification may post to the social marketing application entity's own Facebook wall and Twitter account about fans who have earned badges that week. Links 1462, 1464 and 1466 allow the administrator to link other “official” social network feeds such as Twitter®, YouTube®, and the like, which post information regarding the social marketing entity. This allows information from these “official” feeds to be incorporated into the social marketing entity.

FIG. 15 illustrates a user interface allowing an administrator to create a reward. As noted above, in one embodiment, rewards are linked to acquiring badges and FIG. 15 illustrates a user interface for configuring such rewards. As shown at 1302, the create reward navigation link is highlighted. At 1510, a reward headline may be entered. The reward headline highlights the subject of the reward. A graphic illustrates the location of appearance of the headline in the context of the award. At 1515, the reward details may be entered. The reward details specify the reward being provided (e.g. the Awkward t-shirt from offer 1312 in FIG. 13). At 1520, a reward image may be entered.

Details for redeeming the reward can be entered at 1530 and 1535. Rewards may be redeemed electronically or by other means, such as a physical object being shipped to the user. Where the redemption is electronic, for example, a URL can be entered at 1530 and text describing how the user should redeem their rewards can be entered. Text which may be entered at 1535 can include items such as “e-mail us at xxx@xxx.com to get your reward.”

To target rewards based on completing incentivized activity, badges linked to the reward are selected by a menu at 1540. In one embodiment, one badge is associated with a reward. In alternative embodiments, multiple badges may be required. As noted above, badges may be defined by a provider of the social networking application and defined as earned for numerous different types of social activity including. In alternative embodiments, marketers may define their own badges for specific activity, and chain badges together to create redeemable rewards.

Menu buttons at 1550 allow the reward can be targeted to a specific entity (one entity for the reward) at 1550, or across all entities having social marketing applications enabled. Similarly, the reward can be targeted by a specific country, multiple specific countries or worldwide by selecting countries from the menu at 1560.

Date limits on the distribution can be set at 1570, with drop down calendar selection menus provided to input an offer a start date and end date. An ultimate end-date limit on the redeemability of the reward can be set by a similar drop down menu at 1580. A maximum number of unique clickers (or redeemers) can be set at 1590. This allows the administrator to limit the availability of the reward to a maximum number of redemptions.

The customizations of rewards outlined with respect to FIG. 15 are exemplary and additional customization options may be provided. FIG. 15 is exemplary as to how rewards may be tied to achievement or badges received for incentivized social marketing activity. Once all these settings are enabled, a save changes button 1595 allows the user to commit the changes to the reward. In a manner similar to the interface discussed above, a graphic is associated with each of the entry fields 1510, 1515, 1520, 1530, 1540, 1550, 1570, 1590 which provides the administrator with an indication of how this will be presented on the social marketing enabled entity.

FIG. 16 illustrates a user interface presenting the social network activity feedback for an administrator. The admin panel 1610 indicates that the admin page dashboard, providing feedback for the administrator, is being presented. The admin page includes an install date 1612, the number of fans in the entity 1614, the number of invites sent by users of the entity at 1618, and the total reach, in terms of users invited, contacted, and otherwise messaged by the fans of the entity, at 1620. Panel 1625 provides details on Facebook activity illustrating the number of posts, likes, and comments by users of the social network Facebook participating in the entity's social marketing application relative to the social marketing entity. Likewise, panel 1630 illustrates the activity of users on Twitter relative to the social marketing entity. Panel 1635 illustrates the distribution of Facebook and Twitter badges, and panel 1614 illustrates the distribution of videos on Facebook and Twitter, respectively. Graph 1650 shows the breakdown of male and female users in a pie chart. Graph 1655 shows the breakdown of age and gender of the users of the social marketing entity as a bar graph. Graph 1660 illustrates the activity per month of users participating in the social marketing application of the entity on each of the respective social networking sites Facebook and Twitter in a line graph. Map 1670 shows the geographical distribution of users of the social marketing entity. Export interfaces 1675 and 1680 allow the administrator to export data on the fan chart and fan data to a exported data file format.

It should be understood that the interface elements of FIG. 16 are exemplary and there are numerous ways of presenting and arranging the presentation of data feedback for an administrator.

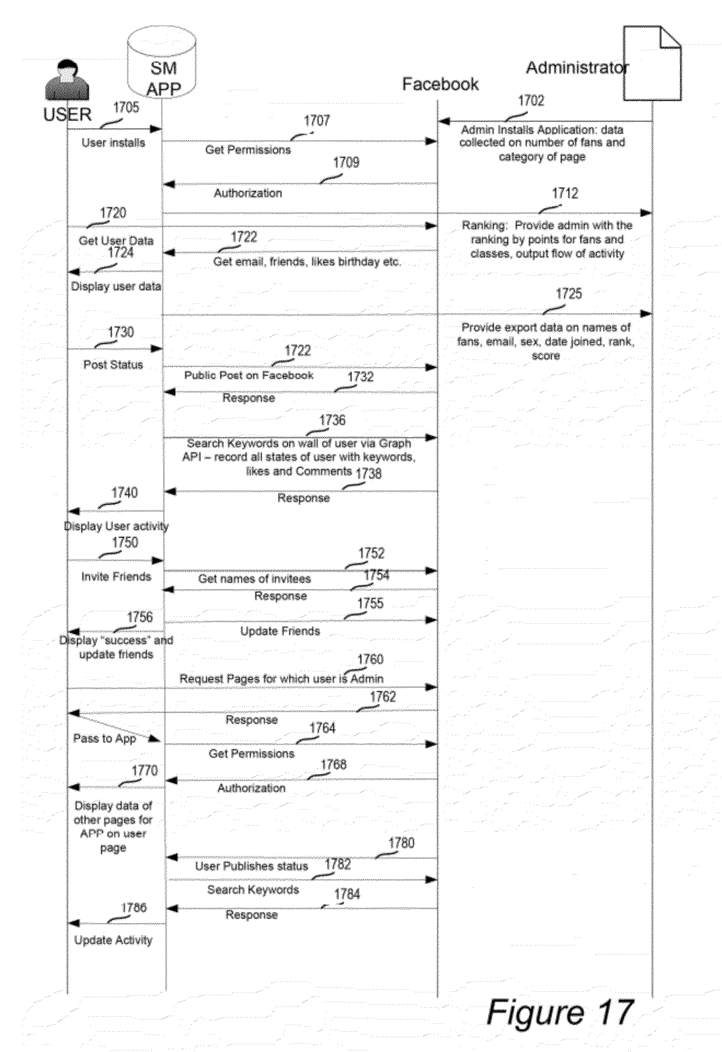

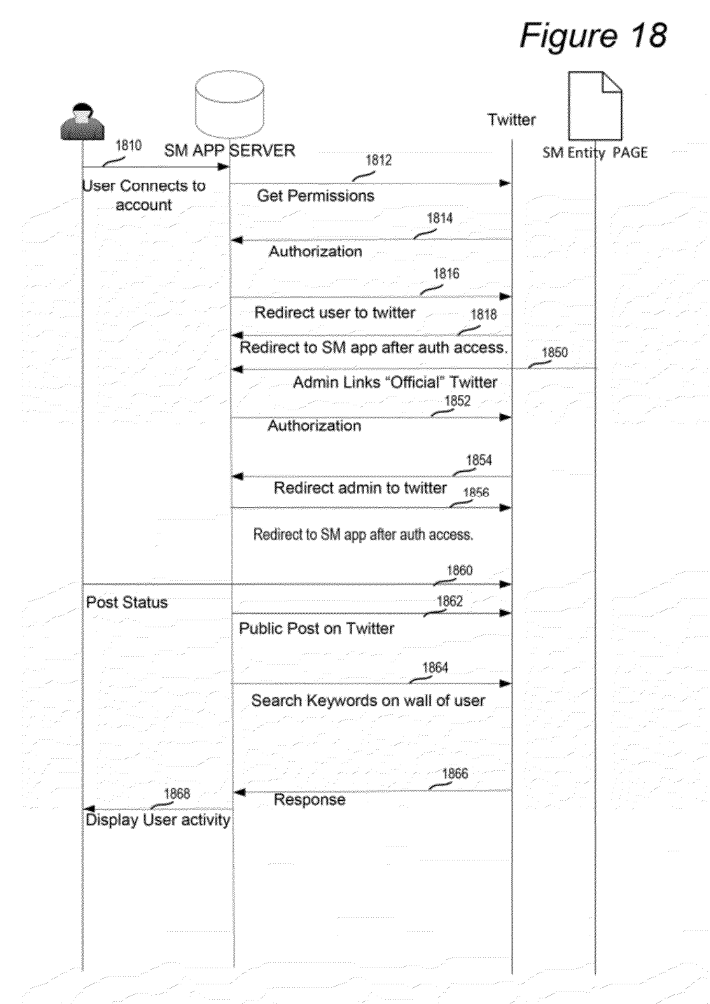

FIGS. 17 and 18 illustrate interactions between an administrator, the social networking application, user, and the specific social marketing sites Facebook® and Twitter®.

As noted above, in one embodiment, the social marketing application is specifically designed to be provided for and interact with the Facebook platform. Among the subscribers of social marketing application, at least some subscribe to one or more servers in the network such as “Facebook”. Thus, each “Facebook” subscriber is connected to the “Facebook” servers and transmits and receives data from “Facebook” as well as the social marketing application.

FIG. 17 illustrates interactions between a user, a social marketing application, Facebook, and the social marketing application administrator. At 1705, a user installs a social marketing application and in doing so, permissions are requested from Facebook at 1707. An authorization is received at 1709. User data is then sought at 1720 and returned at 1722. This user data may be e-mails, friends, likes, birthday, etc. and other profile information of the user. Successful acquisition of this information is displayed to the user at 1724. Likewise, an administrator installs the application and data is collected on the number of fans and the category of the page from Facebook at 1702. Ranking information as well as activity information is returned to the page at 1712 and export data may be provided at 1725 from the application to the page.

When a user publishes a status through the social marketing application at 1730, the application posts the status on Facebook at 1722 which is acknowledged at 1732. A keyword search can then be performed at 1736, searching key words on the user's wall and as well as the user's social graph via the API. This reports all states of the user with key words, likes and comments and results in a response form Facebook at 1738. Successful completion of this activity is displayed to the user at 1740. If a user chooses to invite friends at 1750, the names of the invitees are retrieved at 1752 and returned at 1754. A success message is displayed at 1756. At 1760, the user request to view pages for which the user is an admin, this response is retrieved at 1762. Permissions are provided by the social marketing application at 1764 and an authorization provided at 1768. Once the authorization is provided, data is displayed at 1770. When a user directly chooses to publish their status to Facebook at 1780, key words are then searched at 1782 and a response retrieved at 1784. The activity is updated at 1786 on the user's page.

FIG. 18 illustrates the communication for another social network, in this case Twitter, for a user, the social marketing application, Twitter and the social marketing administrator. At 1810, the user selects to install the social marketing application relative to Twitter the application issues a permissions request token at 1812. Once the authorization is received at 1814, the user may be redirected to Twitter at 1816 to perform an authorization via Twitter's website and then redirected back to the social marketing application after the authorization is a success at 1818. At 1850, as noted above with respect to FIG. 14, an administrator may link an “official” Twitter account to the page at 1850. Again, an authorization is requested at 1852, the administrator is redirected to Twitter at 1854, and back to the social media application at 1856 following authorization. When a user posts status at 1860, a public post is created on Twitter on 1862, and a key word search performed at 1864 for key words of interest on the wall of the user. A response is provided at 1866 and this activity is displayed to the user at 1868.

FIG. 19 illustrates an exemplary mobile device suitable for use in the present technology for any of the processing devices 200 of FIG. 2. FIG. 19 is a block diagram of one embodiment of a mobile device 1900. Mobile devices may include laptop computers, pocket computers, mobile phones, personal digital assistants, and handheld media devices that have been integrated with wireless receiver/transmitter technology.

Mobile device 1900 includes one or more processors 1912 and memory 1910. Memory 1910 includes applications 1930 and non-volatile storage 1940. Memory 1910 can be any variety of memory storage media types, including non-volatile and volatile memory. A mobile device operating system handles the different operations of the mobile device 1900 and may contain user interfaces for operations, such as placing and receiving phone calls, text messaging, checking voicemail, and the like. The applications 1930 can be any assortment of programs, such as a camera application for photos and/or videos, an address book, a calendar application, a media player, an internet browser, games, an alarm application, and other applications, including, for example, a Regimen Controller application comprising code for instructing the processor 1912 to perform the above methods. The non-volatile storage component 1940 in memory 1910 may contain data such as music, photos, contact data, scheduling data, and other files.

The one or more processors 1912 also communicates with RF transmitter/receiver 1906 which in turn is coupled to an antenna 1902, with infrared transmitter/receiver 1908, with global positioning service (GPS) receiver 1965, and with movement/orientation sensor 1914 which may include an accelerometer and/or magnetometer. RF transmitter/receiver 1908 may enable wireless communication via various wireless technology standards such as Bluetooth or the IEEE 802.11 standards. Accelerometers have been incorporated into mobile devices to enable applications such as intelligent user interface applications that let users input commands through gestures, and orientation applications which can automatically change the display from portrait to landscape when the mobile device is rotated. An accelerometer can be provided, e.g., by a micro-electromechanical system (MEMS) which is a tiny mechanical device (of micrometer dimensions) built onto a semiconductor chip. Acceleration direction, as well as orientation, vibration, and shock can be sensed. The one or more processors 1912 further communicate with a ringer/vibrator 1916, a user interface keypad/screen 1918, a speaker 1920, a microphone 1922, a camera 1924, a light sensor 1926, and a temperature sensor 1928. The user interface keypad/screen may include a touch-sensitive screen display.

The one or more processors 1912 controls transmission and reception of wireless signals. During a transmission mode, the one or more processors 1912 provide voice signals from microphone 1922, or other data signals, to the RF transmitter/receiver 1906. The transmitter/receiver 1906 transmits the signals through the antenna 1902. The ringer/vibrator 1916 is used to signal an incoming call, text message, calendar reminder, alarm clock reminder, or other notification to the user. During a receiving mode, the RF transmitter/receiver 1906 receives a voice signal or data signal from a remote station through the antenna 1902. A received voice signal is provided to the speaker 1920 while other received data signals are processed appropriately.

Additionally, a physical connector 1988 may be used to connect the mobile device 1900 to an external power source, such as an AC adapter or powered docking station, in order to recharge battery 1904. The physical connector 1988 may also be used as a data connection to an external computing device. The data connection allows for operations such as synchronizing mobile device data with the computing data on another device.

FIG. 20 illustrates a high level block diagram of a computer system that can be used to implement the present technology and any of the processing devices of FIG. 2. The computer system in FIG. 20 includes processor unit 2000 and main memory 2002. Processor unit 2000 may contain a single microprocessor, or may contain a plurality of microprocessors for configuring the computer system as a multi-processor system. Main memory 2002 stores, in part, instructions and data for execution by processor unit 2000. If the system of the present technology is wholly or partially implemented in software, main memory 2002 can store the executable code when in operation. Main memory 2002 may include banks of dynamic random access memory (DRAM) as well as high speed cache memory.

The system of FIG. 20 further includes mass storage device 2004, peripheral device(s) 2006, user input device(s) 2010, portable storage medium drive(s) 2012, graphics subsystem 2014, and output display 2016. For purposes of simplicity, the components shown in FIG. 19 are depicted as being connected via a single bus 2018. However, the components may be connected through one or more data transport means. For example, processor unit 2000 and main memory 2002 may be connected via a local microprocessor bus, and the mass storage device 2004, peripheral device(s) 2006, portable storage medium drive(s) 2012, and graphics subsystem 2014 may be connected via one or more input/output (I/O) buses. Mass storage device 2004, which may be implemented with a magnetic disk drive or an optical disk drive, is a non volatile storage device for storing data and instructions for use by processor unit 2000. In one embodiment, mass storage device 2004 stores the system software for implementing the present technology for purposes of loading to main memory 2002.

Portable storage medium drive 2012 operates in conjunction with a portable non volatile storage medium, such as a floppy disk, to input and output data and code to and from the computer system of FIG. 19. In one embodiment, the system software for implementing the present technology is stored on such a portable medium, and is input to the computer system via the portable storage medium drive 2012. Peripheral device(s) 2006 may include any type of computer support device, such as an input/output (I/O) interface, to add additional functionality to the computer system. For example, peripheral device(s) 2006 may include a network interface for connecting the computer system to a network, a modem, a router, etc.

User input device(s) 2010 provide a portion of a user interface. User input device(s) 2010 may include an alpha-numeric keypad for inputting alpha-numeric and other information, or a pointing device, such as a mouse, a trackball, stylus, or cursor direction keys. In order to display textual and graphical information, the computer system of FIG. 19 includes graphics subsystem 2014 and output display 2016. Output display 2016 may include a cathode ray tube (CRT) display, liquid crystal display (LCD) or other suitable display device. Graphics subsystem 2014 receives textual and graphical information, and processes the information for output to display 2016. Additionally, the system of FIG. 28 includes output devices 2008. Examples of suitable output devices include speakers, printers, network interfaces, monitors, etc.

The components contained in the computer system of FIG. 20 are those typically found in computer systems suitable for use with the present technology, and are intended to represent a broad category of such computer components that are well known in the art. Thus, the computer system of FIG. 20 can be a personal computer, handheld computing device, Internet-enabled telephone, workstation, server, minicomputer, mainframe computer, or any other computing device. The computer can also include different bus configurations, networked platforms, multi-processor platforms, etc. Various operating systems can be used including Unix, Linux, Windows, Apple OS, and other suitable operating systems.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer implemented method for providing incentives for users to engage in social marketing, comprising:
receiving a plurality of rewards for engaging in directed social activity on behalf of an online entity, the rewards based on user social network activity for the online entity, the online entity representing a product or service;
receiving an association of a plurality of users with the online entity;
providing a user interface for each of the plurality of users associated with the online entity, the interface including the directed social activity associated with the entity;
tracking user social media activity to determine whether a user has achieved the directed social media activity; and
providing a reward to the user based on completed social media activity.

2. The computer implemented method of claim 1 further including computing a user influence rank relative to other users of the entity.

3. The computer implemented method of claim 2 further including calculating a user influence score relative to the user influence rank of all subscribed entities.

4. The computer implemented method of claim 1 wherein each of activity required is defined by an administrator and may be customized to provide a specific reward in return for specific social network activity.

5. The computer implemented method of claim 1 wherein the step of tracking includes tracking activity from a plurality of social networking sites that a user has authorized access to.

6. The computer implemented method of claim 1 wherein the activity comprises one or more of:
publishing a message with a key word defined by the administrator on a social network;
associating the user with the page of the entity on a social network;
purchasing specific products; and
reporting to a location at a specific time.

7. The computer implemented method of claim 1 wherein the activity comprises inviting social network friends to participate in the social marketing application.

8. The computer implemented method of claim 1 providing feedback to the administrator on activities of all users subscribed to the online entity.

9. A computer implemented method for encouraging targeted social network activity to market an online entity, comprising:
associating a social marketing application with an online entity, the online entity representing a product or service;
associating the social marketing application with a plurality of social network users, ones of the social network users subscribing to the social marketing application associated with the online entity;
receiving from an administrator of the entity a reward associated with the achievement of incentivized social activity plurality of, the incentivized social activity based on user social network activity relating to the online entity;
providing the incentivized social activity achievements associated with the entity to the subscribers of the online entity;
tracking user social media activity to determine whether a user has achieved the incentivized activity by engaging in social media activity defined by the offer; and
providing feedback to the administrator on activities of all subscribers to the online entity.

10. The computer implemented method of claim 9 further including computing a user influence rank relative to other users of the online entity based on the social network activity of the user which achieves rewards for the offers.

11. The computer implemented method of claim 10 further including calculating a user influence score relative to the user influence rank of all subscribed online entities.

12. The computer implemented method of claim 11 the achievements are created by an administrator and are customized to provide a specific reward in return for specific social network activity by a user published to friends of the user.

13. The computer implemented method of claim 12 wherein the step of tracking includes tracking activity from a plurality of social networks that a user has authorized access to.

14. The computer implemented method of claim 13 wherein the activity comprises one or more of:
publishing a message with a key word defined by the administrator on a social network;
associating the user with the page of the entity on a social network;
purchasing specific products; and
reporting to a location at a specific time.

15. The computer implemented method of claim 9 wherein the rewards comprise a virtual reward or a physical reward.

16. In a computer system having a graphical user interface including a display and a user interface selection device, a method of providing and selecting from interactive elements on the display, comprising the steps of:
receiving a plurality of rewards associated with the completion of incentivized social activity promoting an online entity, the rewards based on user social network activity promoting the online entity to other users, the online entity representing a product or service, the incentivized activity and associated rewards available to subscribed users of the online entity;
displaying a user interface including one or more offers for the online entity offers associated with the entity;
receiving input in the user interface allowing the user to participate in the one or more offers;
displaying in the user interface for a user rewards achieved by the user, a user level of influence relative to each subscribed online entity, and a user level of influence relative to all online entities;
displaying for an administrator of the online entity at least a configuration interface and a feedback interface, the configuration interface providing one or more inputs to configure a reward, the feedback interface providing data on user activity relative to the online entity and social activity of subscribed users.

17. The method of claim 16 wherein receiving input includes input comprising social networking activity into the user interface, the input being transmitted to the social network.

18. The method of claim 16 the rewards comprise a virtual reward or a physical reward.

19. The method of claim 16 wherein receiving input includes selecting a navigation link directing a subscribed user to a social network to participate in an offer by providing activity on the social network.

20. The method of claim 16 wherein receiving input includes selecting comprises one or more of:
Input to publish a message with a key word defined by the administrator on a social network;
Input to subscribe the user with a page of the entity on a social network; or
Input to purchase specific products of the online entity.
